(19) United States
(12) Patent Application Publication
(10) Pub. No.: US 2015/0327508 A1
(43) Pub. Date: Nov. 19, 2015

(54) Kitty Katch Cat Litter Box

(71) Applicant: Hilbert Maddox, Monroeville, NJ (US)

(72) Inventor: Hilbert Maddox, Monroeville, NJ (US)

(21) Appl. No.: 14/715,517

(22) Filed: May 18, 2015

Related U.S. Application Data
(60) Provisional application No. 61/994,743, filed on May 16, 2014.

(51) Int. Cl. A01K 1/01

(52) U.S. Cl. CPC A01K 1/0114; A01K 1/011

(57) ABSTRACT

The Kitty Katch Cat Litter Box, is a litter box assembly configured to make cleaning up cat excrement less unpleasant and difficult. Kitty Katch is comprised of dual stackable waste bins and one removable screen liner which fits within the base of one designated waste bin and is utilized to remove solid waste. The Kitty Katch's dual waste bins are configured expressly to be interlocking and fit flush within each other.

### CLAIM OF PRIORITY

This patent application claims priority under 35 USC 119 (e) (1) from U.S. Provisional Patent Application Ser. No. 61/994,743 filed May 16, 2014, of common inventorship herewith entitled, “KITTY KATCH CAT LITTER BOX,” which is incorporated herein by reference as though the same were set forth in its entirety.

### FIELD OF THE INVENTION

The present invention pertains to the field of pet hygiene, and more specifically to the field of litter boxes for felines.

### BACKGROUND OF THE INVENTION

The prior art has put forth several designs for litter boxes for felines. Among these are:

U.S. Pat. No. 5,893,336 to Angela G. Poujol, Michael A. Poujol, Anne N. Vice and David W. Vice describes a litter box having a sifter insert member that is used to remove solids and clumped matter from the litter material without removing or transferring the litter material. The sifter insert has a foraminous bottom wall, two opposed side walls, one rear end wall and a transverse front edge extending across the front end of the foraminous bottom wall. The lower portion of the sifter insert is nested slidably in the litter box with its foraminous bottom wall resting on the bottom wall of the litter box. Litter material is sifted by lifting the sifter insert upwardly to capture a substantial portion of solid and clumped material. The sifter insert is reinserted beneath the litter material by holding it in a generally vertical position inwardly adjacent one end wall of the litter box and pushing its front edge downwardly to engage the bottom wall of the litter box and lowering the sifter insert while pushing its front edge along the bottom wall toward the opposed end wall of the litter box until the sifter insert is again nested in the litter box, and thereafter manipulating the litter box to evenly distribute the litter on the sifter insert foraminous bottom wall. The sifter insert also is used to remove remaining solid and clumped materials by holding it at an angle, inserting its front edge into the litter material and pushing it through the litter material beneath the remaining solid and clumped materials and lifting them out of the litter material.

U.S. Pat. No. 4,217,857 to Joseph D. Geddie describes an improved pet relief station for receiving pet excrement. The relief station comprises a screen pan having a screen portion and a pair of receiving pans that are alternatively stackable one in the other. The screen pan is placed in one of the receiving pans, and this pan is in turn stacked in the other receiving pan. Pet litter is disposed in the screen pan to cover the screen portion thereof. Once pet solids have been deposited on the pet litter, the solids are removed by lifting the screen pan, sifting the pet litter which separates the pet solids onto the screen portion, and disposing of the solids. Immediate reassembly of the relief station is afforded by separating the receiving pans, positioning the screen pan in the empty receiving pan, and then pouring the litter over the screen portion of the screen pan. The receiving pans are then restacked.

U.S. Pat. No. 3,752,120 to Sam W. Pallesi describes a sanitary litter box for cats, which is cleaned readily of refuse. The device consists of three nesting containers, the uppermost having a screen bottom, with handholds on the side of each container. The containers are housed in a removable hood, shaped in the form of a house, with an open door for the cat to enter or leave the device. In use, the uppermost container is filled partially with sand, after being nested over the other two containers. At periodic intervals, the solid matter is screened by lifting this uppermost container, and permitting the sand to fall through the screen into the next lower container. After the refuse lying on the screen is disposed, the screen bottom container is nested into the remaining empty container, and the sand is poured into it from the storage container, which when empty, is nested under the other containers to become the bottom container.

None of these prior art references describe the present invention.

### SUMMARY OF THE INVENTION

It is an object of the present invention to provide a kitty litter box comprising dual stackable waste bins and a removable screen liner bin.

### BRIEF DESCRIPTION OF THE DRAWINGS

FIG. 1 is a prototypical diagonal view of all components of the present invention nestled together ready to be used.

FIG. 2 is an illustrative functional diagonal view showing a screen bottom bin that is lifted up to separate waste from two stackable litter bins arranged as the base of the present invention.

FIG. 3 is an illustrative functional top down view showing how the emptied screen bottom bin is placed in the bottom most stackable bin and the litter from the top stackable litter bin that was removed from the bottom stackable bin is poured into the screen bottom bin and bottom most stackable bin.

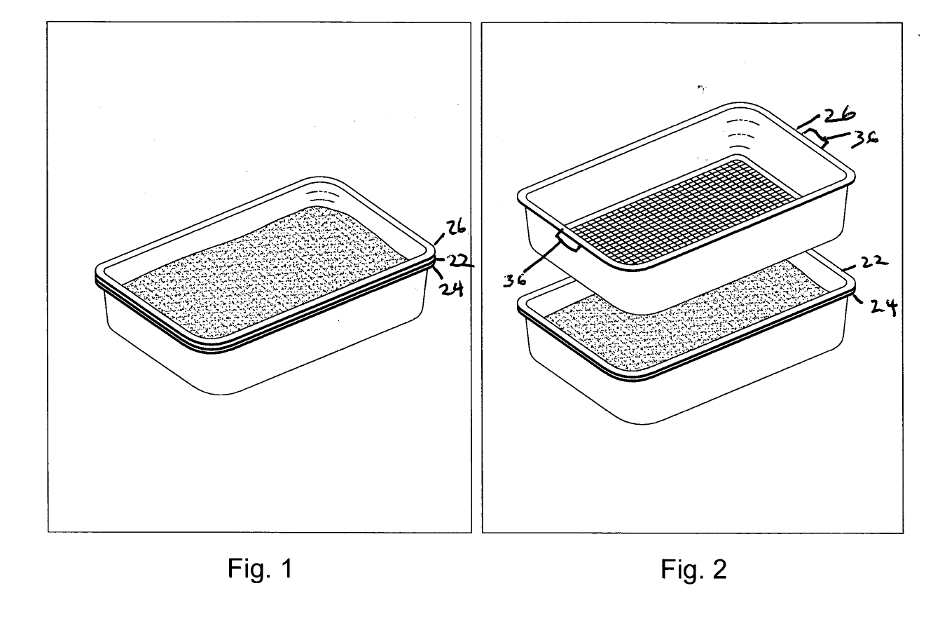

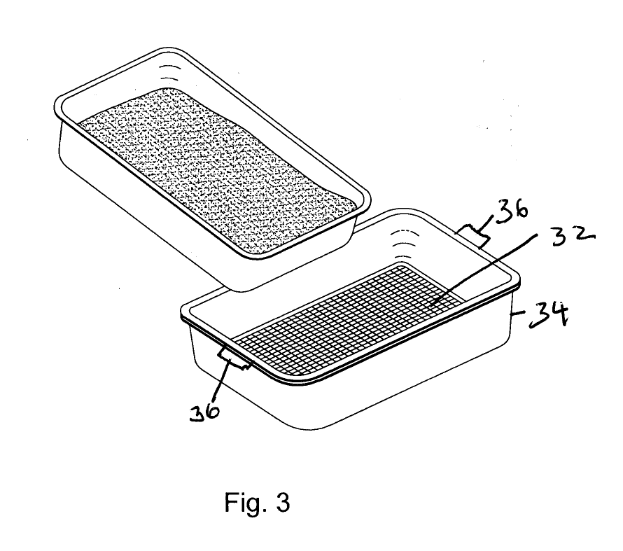

### DETAILED DESCRIPTION OF THE INVENTION

Cats are extremely popular as household pets. Soft and snugly, these furry creatures provide unconditional love, loyalty and companionship to their owners. Skilled hunters, cats are renowned for their agility, remarkable memory, and keen sense of sight and smell. With a life expectancy of over fifteen years, most people consider their cats to be more than just a pet, but rather a member of the family. Arguably intelligent, cats are self grooming and most importantly, easily trained in using a litter box.

Litter boxes are a necessity for individuals who own indoor cats. Providing a feline animal with a sanitary and recognizable inside space for eliminating bodily waste, litter boxes are an important addition in any cat home. Most litter boxes are made of plastic, rectangular in shape-and filled with specially treated sand or clay litter to eliminate odor. Cats are motivated naturally to use these receptacles, but litter boxes present a major drawback of having to be cleaned on a regular basis by a cat owner. Most cat owners change the litter in the litter box on a weekly basis. To maintain a litter box throughout the week, conscientious pet owners scoop solid waste from the box on a daily basis. Using a small, handheld shovel like scoop, cat owners scoop solid waste from the box and toss this waste into a trash receptacle. Considering that most cats eliminate waste several times a day, scooping solid or clump waste from a litter box is an unpleasant and time consuming task.

The present invention, hereinafter referred to as Kitty Katch Cat Litter Box, or simply Kitty Katch, is a litter box assembly configured to make cleaning up cat excrement less unpleasant and difficult. Kitty Katch is comprised of dual stackable waste bins 22, 24 and one removable screen liner 26 which fits within the base of one designated waste bin and is utilized to remove solid waste. The Kitty Katch's dual waste bins 22, 24 are configured expressly to be interlocking and fit flush within each other. Each bin is a rectangularly shaped receptacle measuring between approximately four to six inches in height, fourteen to sixteen inches in width and eighteen to twenty inches in total length. These bins have raised side walls that enclose the litter within the bin and are easily stacked, one within the other. The upper bin is filled with cat litter, and the lower bin is empty and positioned directly below the upper bin.

The removable screen liner bin 26 is sized appropriately to easily fit within the designated upper bin 22 during use, lining the bin 22 completely. This liner bin 26 comprises raised plastic side walls 34 around its perimeter while the liner bin's base is comprised of rust resistant metal screen 32. This metal screen 32 encompasses the bottom of the upper bin 32 in which it is placed. Sturdy, raised handles 36 are positioned at each end of the liner bin to facilitate easy handling of the device. An oversized, rectangularly shaped rubber mat is included for use with the Kitty Katch to collect errant sand kicked out of the box by the cat during use. This mat contains an integrated crease that runs the length of the mat, for use in easily folding the mat to pour the errant litter back into the litter bin. Kitty Katch is manufactured in a variety of striking colors, as well as understated neutral hues.

Use of Kitty Katch is simple and straight forward. First, a user stacks the two interlocking kitty litter bins so that one bin rests within the other bin, and the two were secured together. The user then places the screen liner bin within the upper litter bin, positioning it so that the metal screen liner rests flush against the bottom of the bin, while its raised side walls rest against the interior perimeter of the upper litter bin. The user pours kitty litter within the upper bin, directly over the screen liner, thus readying the present invention for use. After solid and clumped waste has accumulated in the box, the pet owner removes this waste matter by lifting the screen liner bin out of the upper bin by way of its integrated handles. As the screen liner bin is pulled from the base of the litter bin, the loose kitty litter easily passes through the metal screen liner and falls back into the upper litter bin, while clumped or solid waste matter remains on the surface of the screen liner. The user pours this waste into an appropriate trash receptacle for easy disposal. The user then removes the empty litter bin from its position beneath the upper litter bin, places the clean screen liner within the empty bin, and pours kitty litter from the upper litter bin over the metal screen liner into the just removed bottom empty bin. The litter bin which previously was the upper bin now is empty and is rotated below the filled litter bin to become the bottom litter bin. This process is repeated throughout the week to remove solid waste and aerate the kitty litter, with the user disposing of the litter and replacing it with fresh kitty litter as deemed necessary.

Providing a hygienic solution to problems associated with managing feline pet waste, using Kitty Katch ensures a clean and healthy environment for animals and human residents. Easy to use and durably constructed, the present invention is highly effective and functional for use in households, veterinary clinics, pet boarding facilities, pet groomers and animal shelters.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A kitty litter box comprising: rectangularly shaped dual stackable waste bins and a removable screen liner bin, wherein all three bins are configured expressly to be interlocking and fit flush within each other; wherein the two stackable waste bins comprise raised side walls that enclose the litter within the bin and are easily stacked, one within the other, wherein the upper bin is filled with cat litter, and the lower bin is empty and positioned directly below the upper bin, further wherein the removable screen liner bin is sized appropriately to easily fit within the designated upper bin during use, lining the upper bin completely, and wherein the liner bin comprises raised plastic side walls around its perimeter and the liner bin's base is comprised of rust resistant metal screen.

2. The kitty litter box of claim 1 wherein each bin is a rectangularly shaped receptacle measuring between approximately four to six inches in height, fourteen to sixteen inches in width and eighteen to twenty inches in total length.

3. The kitty litter box of claim 1 wherein the removable screen liner bin further comprises sturdy, raised handles positioned at each end of the liner bin to facilitate easy handling of the device.

4. The kitty litter box of claim 1 manufactured in a variety of striking colors, as well as understated neutral hues.
